(19) United States
(12) Patent Application Publication
(10) Pub. No.: US 2004/0262996 A1
(43) Pub. Date: Dec. 30, 2004

(54) Phase conversion device with built-in demand reduction / power boosting.

(76) Inventors: Ib Ingemann Olsen, New York, NY (US); Nicholas Blaise Pasquale, Somer, NY (US)

Correspondence Address: JEFFREY FURR, 253 N. MAIN STREET, JOHNSTOWN, OH, 43031, US

(21) Appl. No.: 10/710,234

(22) Filed: Jun. 28, 2004

Related U.S. Application Data
(60) Provisional application No. 60/482,986, filed on Jun. 30, 2003.

(51) Int. Cl. H02H 7/00

(52) U.S. Cl. 307/44; 361/18

(57) ABSTRACT

The current invention consist of a Phase conversion device with built-in demand reduction/power boosting device where Single phase AC is converted to DC and connected to a DC storage device, which again is connected to a DC to three phase AC converter and where a single phase AC is feed into a current limiting device and then into a single phase to three phase AC converter. A DC storage device with a DC to single phase AC converter is connected between the current limiting device and the AC to AC phase converter.

### CROSS REFERENCE TO RELATED APPLICATIONS

This application is a non-provisional tha claims the priority date of provisional application 60/482,986 filed Jun. 30, 2003.

### BACKGROUND OF INVENTION

The invention relates to a device that converts single-phase AC power from any source to three-phase AC power while incorporating a DC energy storage device that can boost the electricity supply for a limited duration if the load using the three-phase power needs more power than the single-phase can or is allowed to provide.

Prior Art Single phase to three phase conversion existed in prior art such as Rotary phase converters by Tower Electric Motor Company and Solid state converters by Tower Electric Motor Company. Either a static or rotary phase converter can make it possible to run a three-phase motor on single-phase power. The static phase converter does not actually generate three-phase power continuously as a rotary phase converter does, but only long enough for it to start up. With the static phase converter once the motor has started the converter circuitry disconnects itself and the motor continues to run on single-phase power, but because only two of three windings get power during running, power output is reduced to ⅔. A fifteen horse-power motor will start with the power of a fifteen but run as a ten for example. The use of heavy machinery creates high spikes in the electricity demand for short durations, but long enough to penalize businesses with higher electricity demand charges.

Three phase power is not readily available in all places and must be brought in at high cost. There is still room for improvement in the art.

### SUMMARY OF INVENTION

The current invention consists of a phase conversion device with built-in demand reduction/power boosting device where Single phase AC is converted to DC and connected to a DC storage device, which again is connected to a DC to three phase AC converter and where a single phase AC is fed into a current limiting device and then into a single phase to three phase AC converter. A DC storage device with a DC to single phase AC converter is connected between the current limiting device and the AC to AC phase converter.

### BRIEF DESCRIPTION OF DRAWINGS

Without restricting the full scope of this invention, the preferred form of this invention is illustrated in the following drawings:

FIG. 1 displays the components and configuration of the 1^{st} implementation of the Device; and

FIG. 2 displays the components and configuration of the 2nd implementation of the Device.

### DETAILED DESCRIPTION

The following description is demonstrative in nature and is not intended to limit the scope of the invention or its application of uses.

There are a number of significant design features and improvements incorporated within the invention.

There are two configurations of the current invention.

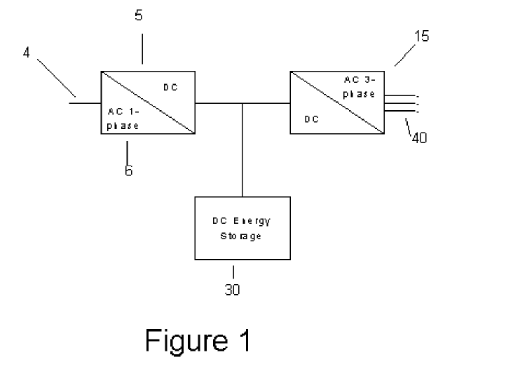

As shown in FIG. 1, in the first configuration a single phase AC 6 is converted to DC 5 and connected to a DC storage device 30, which again is connected to a DC to three phase AC converter 15. The DC 5 to three phase AC converter 15 can be generated using a speed controlled DC motor with a three phase AC generator, or using three solid state DC to AC inverters operated 120 degree shifted from each other.

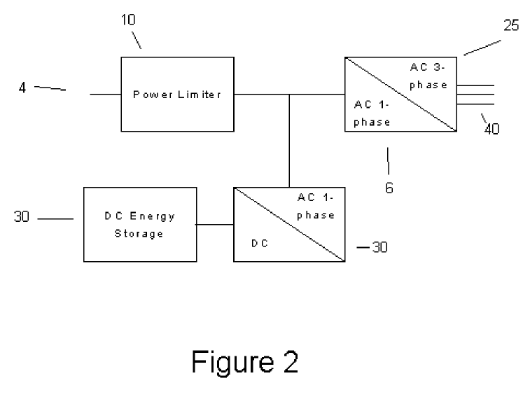

As shown in FIG. 2, the second configuration a single phase AC 6 is fed into a current limiting device 10 and then into a single phase to three phase AC converter 25. A DC storage device 30 with a DC to single phase AC converter 35 is connected between the current limiting device 10 and the AC to AC phase converter 25. A single phase AC 6 is fed into a current limiting device 10 and then into a single phase to three-phase AC converter 25. A DC storage device 30 with a DC to single phase AC converter 35 is connected between the current limiting device 10 and the AC to AC phase converter 25.

In the preferred embodiment, the DC storage device 30 can consist of but is not limited to rechargeable batteries such as lead-acid, nickel cadmium, nickel metal hydride, and nickel zinc based technologies; it can be capacitors or super capacitors; or it can be combinations hereof.

The power drain from the grid 4 is controlled by the first stage of the invention, which is fed single phase AC power 6. The power is used partly to charge the DC storage device 30 and is partly converted into three phase AC power using a static or rotary phase converter 40.

Operation

When a load such as a lathe is turned on the power demand is initially high and can exceed the power drain allowed by the first stage and additional power is supplied from the DC energy source 30. The DC energy source 30 will supply the additional power until the power is no longer needed or until the DC energy storage 30 is depleted. The proper sizing of the DC energy storage will minimize the risk of depletion.

The phase conversion unit with demand reduction can be either stationary or mobile.

Alternative Embodiment

In one embodiment the device 1 can provide three-phase power for a limited time without a steady supply from a single-phase source and can be used to power machinery long enough to safely shut them down without loosing valuable production.

Advantages

This invention has several benefits over prior art. It reduces the power draw from the single-phase source and may avoid costly electrical upgrades to the wiring. It reduces the power demand from a facility and thereby reduces the demand charges the user may be charged by the electrical utility. It can provide limited power backup in case of electrical blackout. It differs from conventional three-phase uninterruptible power supplies in that the invention is always on and it converts single-phase power to three phases. The use of three-phase power enables the use of smaller electrical motors than possible with single-phase power.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A power device, comprising:
A single phase AC to DC converter connected to a DC storage device and connected to a DC to three phase AC converter.

2. A device as in claim 1 where said DC to three phase AC converter is a speed controlled DC motor.

3. A device as in claim 2 where said speed controlled DC motor has a three phase AC generator.

4. A device as in claim 1 wherein said single phase AC to DC converter is connected to a power grid.

5. A device as in claim 1 where said DC to three phase AC converter is three DC to AC inverters.

6. A device as in claim 1 wherein said DC to AC inverters operate 130 degrees shifted from each other.

7. A device as in claim 1 wherein said DC storage device is a plurality of rechargeable batteries.

8. A device as in claim 1 wherein said DC storage device is a plurality of capacitors.

9. A device as in claim 1 where said DC storage device is a plurality of capacitors and a plurality of rechargeable batteries.

10. A device as in claim 1 wherein power from a power grid is used to charge said DC storage device and convert to three phase AC power.

11. A power converter device, comprising:
A single phase AC is fed into to limiting device, said limiting device connected to a AC to DC single phase converter connected to DC storage device and connected to a AC to three phase AC converter.

12. A device as in claim 11 where said DC to three phase AC converter is a speed controlled DC motor.

13. A device as in claim 12 where said speed controlled DC motor has a three phase AC generator.

14. A device as in claim 11 wherein said single phase AC to DC converter is connected to a power grid.

15. A device as in claim 11 where said DC to three phase AC converter is three DC to AC inverters.

16. A device as in claim 11 wherein said DC to AC inverters operate 130 degrees shifted from each other.

17. A device as in claim 11 wherein said DC storage device is a plurality of rechargeable batteries.

18. A device as in claim 11 wherein said DC storage device is a plurality of capacitors.

19. A device as in claim 11 where said DC storage device is a plurality of capacitors and a plurality of rechargeable batteries.

20. A device as in claim 11 wherein power from a power grid is used to charge said DC storage device and convert to three phase AC power.
